(19) United States
(12) Patent Application Publication
(10) Pub. No.: US 2020/0301333 A1
(43) Pub. Date: Sep. 24, 2020

(54) IMAGE FORMING APPARATUS AND OPERATION METHOD THEREOF

(71) Applicant: TOSHIBA TEC KABUSHIKI KAISHA, Tokyo (JP)

(72) Inventor: Yushi YONEZAWA, Atsugi Kanagawa (JP)

(21) Appl. No.: 16/359,019

(22) Filed: Mar. 20, 2019

(51) Int. Cl. G03G 15/00

(52) U.S. Cl. CPC G03G 15/5016; G03G 2215/00548; G03G 15/70

(57) ABSTRACT

An image forming apparatus includes an image transfer device, an image fixing device disposed downstream with respect to the image transfer device in a sheet conveying direction, one or more sheet sensors disposed along a sheet conveying path, a control panel, and a controller. The image fixing device is configured to fix a toner image transferred onto a sheet by the image transfer device. The controller is configured to determine whether or not a jammed sheet is at least partially positioned between the image transfer device and the image fixing device based on a detection result of the one or more sheet sensors. The controller is further configured to control the control panel to display different procedures to handle the jammed sheet, depending on the determination whether or not the jammed sheet is at least partially positioned between the image transfer device and the image fixing device.

### FIELD

Embodiments described herein relate generally to an image forming apparatus and an operation method.

### BACKGROUND

An image forming apparatus such as a multifunction peripheral (MFP) form an image on a sheet. Hereinafter, an image forming on a sheet maybe referred to as “printing.” The sheet mentioned here includes not only general printing paper but also envelopes, paper with integrated circuit (IC) chips, overhead projector (OHP) sheet, special processed paper (for example, laminated paper and waterproof paper) and the like.

During printing performed by the image forming apparatus, the sheet may be blocked in the image forming apparatus. Hereinafter, blocking of the sheet in the image forming apparatus maybe referred to as “jamming.” When jamming occurs, the sheet blocked in the image forming apparatus (hereinafter “jammed sheet”) may need to be removed by a user from the image forming apparatus. Depending on a jamming spot in the image forming apparatus, toner which is not fixed (hereinafter referred to as “unfixed toner”) may be formed on the jammed sheet in some cases.

In the related art, removed jammed sheets were generally discarded by the user. On the other hand, toner which can be decolored by heating (hereinafter referred to as “decoloring toner”) may be used in some cases. In printing performed with such decoloring toner, the user may decolor the decoloring toner on the removed jammed sheets and reuse the decolored sheets. For example, to decolor the decoloring toner, the user may feed the removed jammed sheet to mechanisms such as a decoloring device that decolors decoloring toner (hereinafter referred to as “decoloring unit”). At this time, depending on a method of feeding sheet to the decoloring unit, the unfixed toner on the jammed sheet fed to the decoloring unit may contact paper feeding roller (pickup roller) of the decoloring unit and may be attached to the paper feeding roller. When the unfixed toner is attached to the paper feeding roller, sheets to be fed may slip and therefore sheet feeding may not be properly performed.

It is not easy for the user to determine whether toner on the jammed sheet is unfixed toner. Further, when duplex printing is performed, it is not easy to determine which surfaces of the jammed sheet has unfixed toner. Thus, it may be difficult for the user to know whether any of the jammed sheets can be fed to the decoloring unit.

### BRIEF DESCRIPTION OF THE DRAWINGS

FIG. 1 illustrates an exterior view of an image forming apparatus according to a first embodiment.

FIG. 2 is a diagram illustrating a configuration example of a printer.

FIG. 3 is a block diagram illustrating a functional configuration of the image forming apparatus.

FIG. 4 is a flowchart illustrating an operation example of the image forming apparatus.

FIG. 5 is a schematic diagram illustrating a display example of a first notification.

FIG. 6 is a schematic diagram illustrating a display example of a second notification.

FIG. 7 is a flowchart illustrating an operation example of the image forming apparatus according to a second embodiment.

FIG. 8 is a schematic diagram illustrating a display example of a third notification.

FIG. 9 is a flowchart illustrating an operation example of the image forming apparatus according to a third embodiment.

### DETAILED DESCRIPTION

An exemplary embodiment provides an image forming apparatus and a notification method capable of notifying a user of an appropriate countermeasure method when jamming occurs.

In general, according to an embodiment, an image forming apparatus includes an image transfer device, an image fixing device disposed downstream with respect to the image transfer device in a sheet conveying direction, one or more sheet sensors disposed along a sheet conveying path, a control panel, and a controller. The image fixing device is configured to fix a toner image transferred onto a sheet by the image transfer device. The controller is configured to determine whether or not a jammed sheet is at least partially positioned between the image transfer device and the image fixing device based on a detection result of the one or more sheet sensors. The controller is further configured to control the control panel to display different procedures to handle the jammed sheet, depending on the determination whether or not the jammed sheet is at least partially positioned between the image transfer device and the image fixing device.

Hereinafter, an image forming apparatus and a notification method according to embodiments will be described with reference to the drawings.

### First Embodiment

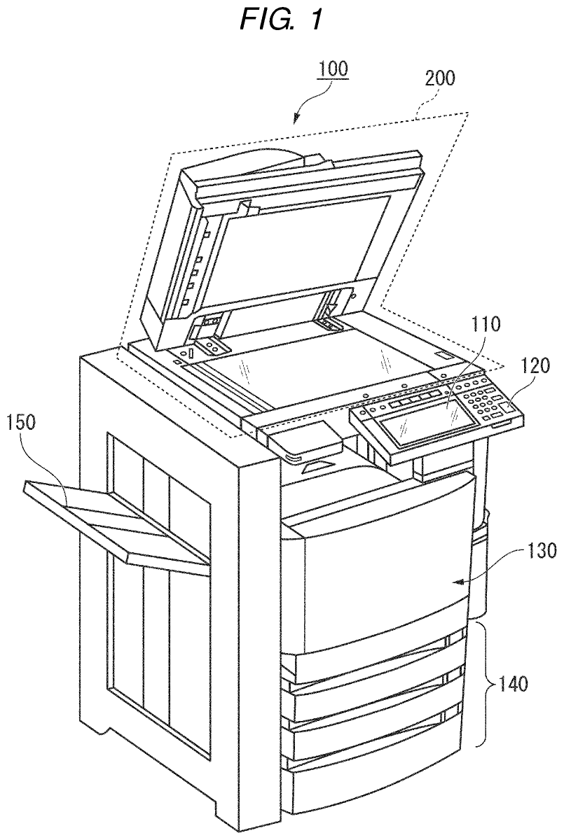

FIG. 1 illustrates an exterior view of an image forming apparatus 100 according to a first embodiment. The image forming apparatus 100 is, for example, a multifunction peripheral. The image forming apparatus 100 includes a display 110, a control panel 120, a printer 130, a sheet accommodation unit 140, a finisher 150, and an image reading unit 200.

The image forming apparatus 100 forms an image on a sheet using, for example, a developer such as toner. As the toner, there are toner which cannot be decolored (hereinafter referred to as “non-decoloring toner”) and decoloring toner. An image formed with decoloring toner on a sheet is decolored at a temperature equal to or greater than a predetermined temperature. The sheet may be any object as long as the image forming apparatus 100 can form an image on a surface of the object.

The display 110 is, for example, an image display device such as a liquid crystal display or an organic electro-luminescence (EL) display. The display 110 displays various kinds of information regarding the image forming apparatus 100. The various kinds of information mentioned here include not only information used to present an operation screen, a state of a printing process, and the like to a user but also information used to notify the user an appropriate countermeasure method, for example, when jamming occurs.

The control panel 120 includes a plurality of buttons. The control panel 120 receives an operation from the user. The control panel 120 outputs a signal suitable for the operation performed by the user to a control unit of the image forming apparatus 100. The display 110 and the control panel 120 may be configured as an integrated touch panel.

The printer 130 forms an image on a sheet based on image information generated by the image reading unit 200 or image information received via a communication path. The printer 130 forms an image by, for example, a process to be described below. An image forming unit of the printer 130 forms an electrostatic latent image on a photoconductive drum based on the image information. The image forming unit of the printer 130 forms a visible image by attaching a developer to the electrostatic latent image. As described above, there is toner as a specific example of the developer. A transfer unit of the printer 130 transfers the visible image to a sheet. A fixing unit of the printer 130 fixes the visible image to the sheet by heating and pressurizing the sheet. The sheet on which the image is formed may be a sheet accommodated in the sheet accommodation unit 140 or may be a manually input sheet.

When duplex printing is performed to form images on both surfaces of a sheet, the front and the rear surfaces, the printer 130 forms an image on one of the surfaces of the sheet and then forms an image on the other surface. Hereinafter, of the front surface and the rear surface, a surface on which printing is first performed on the sheet is referred to as a first surface and a surface on which printing is performed after the first surface is referred to as a second surface.

The sheet accommodation unit 140 accommodates sheets to be used in image forming by the printer 130. A sheet on which an image is formed by the printer 130 is discharged to the finisher 150.

The image reading unit 200 obtains image information of a reading target based on brightness and darkness of light. The image reading unit 200 records the image information. The recorded image information may be transmitted to another information processing apparatus via a network. The recorded image information may be formed as an image on a sheet by the printer 130.

Hereinafter, a configuration of the printer 130 will be described.

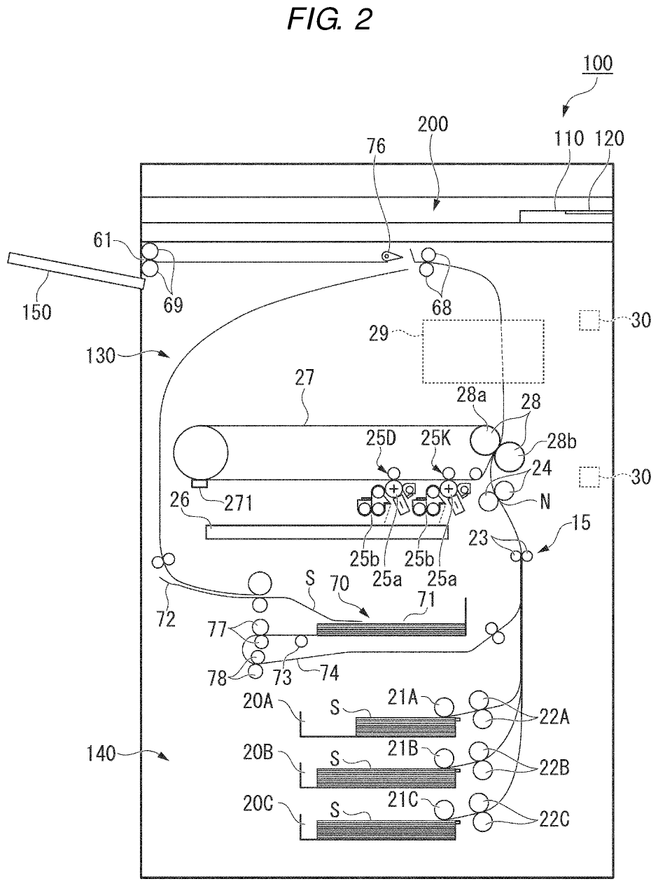

FIG. 2 is a diagram illustrating a configuration example of the printer 130.

The sheet accommodation unit 140 includes a plurality of paper feeding cassettes 20A, 20B, and 20C. The paper feeding cassettes 20A, 20B, and 20C each accommodate sheets (S) with sizes and types set in advance. The paper feeding cassettes 20A, 20B, and 20C include pickup rollers 21A, 21B, and 21C, respectively. The pickup rollers 21A, 21B, and 21C extract sheets one by one from the paper feeding cassettes 20A, 20B, and 20C, respectively. The pickup rollers 21A, 21B, and 21C each supply the extracted sheet to a transport path 15.

The transport path 15 transports a sheet in the printer 130 and the sheet accommodation unit 140. The transport path 15 includes transport roller 23 and register roller 24. The transport path 15 transports a sheet supplied from any of the pickup rollers 21A, 21B, and 21C to the register roller 24. The register roller 24 transports the sheet according to a timing at which a transfer unit 28 of the printer 130 to be described below transfers a toner image to a surface of the sheet. The transport roller 23 causes a leading end of the sheet in a transport direction to enter a nip N of the register roller 24. The transport roller 23 aligns the position of the leading end of the sheet in the transport direction by curving the sheet. The register roller 24 transports the sheet to the transfer unit 28 side after the leading end of the sheet sent from the transport roller 23 is aligned at the nip N.

The printer 130 includes image forming units 25K and 25D, an exposure unit 26, an intermediate transfer belt 27, the transfer unit 28, a fixing unit 29, and a detection unit 30. Each of the image forming units 25K and 25D forms a toner image to be transferred to the sheet. Each of the image forming units 25K and 25D includes a photoconductive drum 25a. Further, each of the image forming units 25K and 25D includes a development device 25b that selectively supplies toner to the surface of the respective photoconductive drum 25a. The development device 25b of the image forming unit 25K accommodates non-decoloring toner. The development device 25b of the image forming unit 25D accommodates decoloring toner. The decoloring toner is formed as an image by the image forming unit 25D that has a configuration similar to the configuration of the image forming unit 25K.

The exposure unit 26 faces the photoconductive drum 25a of each of the image forming units 25K and 25D. The exposure unit 26 radiates laser light based on image data to the surface of the photoconductive drum 25a of each of the image forming units 25K and 25D. The exposure unit 26 forms an electrostatic latent image on the surface of the photoconductive drum 25a of each of the image forming units 25K and 25D by radiating the laser light. Each development device 25b develops the electrostatic latent image by supplying toner to the electrostatic latent image on the surface of each photoconductive drum 25a. Each development device 25b forms (develops) a toner image by attaching the charged toner to the electrostatic latent image on the surface of each photoconductive drum 25a. The development device 25b of the image forming unit 25K develops the electrostatic latent image on the surface of the photoconductive drum 25a using black toner. The development device 25b of the image forming unit 25D develops the electrostatic latent image on the surface of the photoconductive drum 25a using decoloring toner.

The image forming units 25K and 25D each transfer (primarily transfer) the toner images charged on the surfaces of the respective photoconductive drums 25a to the surface of the intermediate transfer belt 27. The image forming units 25K and 25D each supplies a transfer bias to the toner images of the respective photoconductive drums 25a at primary transfer positions at which primary transfer rollers and the intermediate transfer belt 27 come into contact with each other. The image forming units 25K and 25D each transfer the toner images of respective colors on the respective photoconductive drums 25a to overlap each other on the surface of the intermediate transfer belt 27. The image forming unit 25K forms a non-decoloring toner image by transferring the toner image to overlap on the surface of the intermediate transfer belt 27. The image forming unit 25D transfers a decoloring toner image to the intermediate transfer belt 27.

The transfer unit 28 includes a support roller 28a and a secondary transfer roller 28b interposing the intermediate transfer belt 27 and a sheet from both sides in the thickness direction. A position at which the support roller 28a and the secondary transfer roller 28b face each other is a secondary transfer position. The support roller 28a has a function as a counter electrode of the secondary transfer roller 28b. The transfer unit 28 transfers the toner images charged on the surface of the intermediate transfer belt 27 to the surface of the sheet by supplying the transfer bias corresponding to a transfer current to the secondary transfer position.

The remaining toner on the intermediate transfer belt 27 not transferred to the sheet by the transfer unit 28 is cleaned by a cleaning unit 271. The cleaning unit 271 causes the tip of a blade to contact and pressures the intermediate transfer belt 27 to scrape the toner off the intermediate transfer belt 27. The cleaning unit 271 may bring a charged brush into contact with the intermediate transfer belt 27.

The fixing unit 29 is disposed downstream from the transfer unit 28 in a transport direction along the transport path 15 which is a transport path of a sheet. For the upstream and downstream sides mentioned here, a position to which a sheet arrives earlier in the transport path 15 in which a sheet is transported from each of the paper feeding cassettes 20A, 20B, and 20C to the finisher 150 is referred to as an upstream side and a position to which the sheet arrives later relatively than the upstream side position is referred to as a downstream side. The fixing unit 29 fixes the toner images to the sheet at a fixing temperature in a normal operation mode. The fixing unit 29 decolors the decoloring toner formed on the sheet at a decoloring temperature higher than the fixing temperature in a decoloring mode. Here, the decoloring temperature is a temperature of the fixing unit 29 sufficient to decolor the decoloring toner formed on the sheet. The decoloring temperature is higher than a temperature above which the decoloring toner is decolored and is determined according to a thermal capacity of the sheet or a passing speed of the sheet in the fixing unit 29. As the fixing unit 29, for example, an induction heating (IH) heater including a heated member generating heat by an alternating-current magnetic field can be used. By using the IH heater, it is possible to easily control the temperature of the fixing unit 29.

A pair of paper feeding rollers 68 and a pair of paper discharge rollers 69 discharge the sheet on which an image is formed to the finisher 150 through a discharge port 61. A duplex printing device 70 is provided below the exposure unit 26. The duplex printing device 70 reverses the sheet passing through the fixing unit 29 and sends the sheet to the transport roller 23 again, according to a first-in first-out (FIFO) scheme. The duplex printing device 70 includes a temporary accumulation unit 71, a transport path 72, a pickup roller 73, and paper feeding rollers 77 and 78. The temporary accumulation unit 71 temporarily accumulates (stacks) the sheet. The transport path 72 branches the sheet passing through the fixing unit 29 from the transport path 15 and guides the sheet to the temporary accumulation unit 71. The pickup roller 73 sequentially extracts the sheets accumulated in the temporary accumulation unit 71 one by one. The paper feeding rollers 77 and 78 feed the extracted sheet to the transport roller 23 through a transport path 74. A distribution gate 76 is provided in a branch portion between the transport path 15 and the transport path 72. The distribution gate 76 selectively distributes the sheet to the transport path 15 leading to the discharge port 61 or the transport path 72 of the duplex printing device 70.

When images are formed on both surfaces of a sheet, the sheet passing through the fixing unit 29 is guided to the transport path 72 by the distribution gate 76 and is sequentially stacked in the temporary accumulation unit 71. The sheet temporarily accumulated in the temporary accumulation unit 71 is extracted to the pickup roller 73 sequentially from the lowermost sheet among the stacked sheets. The extracted sheet is reversed in the transport path 74. After the sheet is reversed, the sheet is sent to the transport roller 23. After the sheet is adjusted by the transport roller 23, the sheet is transported to the transfer unit 28 again. The transfer unit 28 transfers a toner image to a surface different from the surface of the sheet on which the image is first formed. The fixing unit 29 fixes the toner image to the sheet at the fixing temperature. The sheet which passed through the fixing unit 29 is discharged from the discharge port 61 to the finisher 150 via the pair of paper feeding rollers 68 and the pair of paper discharge rollers 69.

The detection unit 30 is a sensor that detects a position of a jammed sheet (hereinafter referred to as a “remaining position”) remaining in the transport path 15 inside the image forming apparatus 100 when jamming occurs. The detection unit 30 is located, for example, at each spots of the transport path 15 where the sheet is drawn into the transfer unit 28 and where the sheet is discharged from the fixing unit 29. The detection unit 30 is, for example, a sensor that includes a sensor lever. When a transported sheet passes the detection unit 30, the sensor lever is pushed by the leading end of the sheet. Thus, the detection unit 30 can detect that the transported sheet arrived up to the position where the detection unit 30 is located.

The printer 130 can also reverse the front surface and the rear surface of a sheet in which images are formed on the both surfaces and discharge the sheet to the finisher 150. In this case, the distribution gate 76 guides the sheet in which the images are formed on the both surfaces to the transport path 72. Thus, the sheet is accumulated in the temporary accumulation unit 71 and the sheet is fed to the transport roller 23 along the transport path 74 again. The printer 130 does not form an image on the sheet in which the images are formed on the both surfaces. The sheet passes through the transfer unit 28 and the fixing unit 29 without forming an image, and is discharged from the discharge port 61 to the finisher 150 via the pair of paper feeding rollers 68 and the pair of paper discharge rollers 69.

Hereinafter, a functional configuration of the image forming apparatus 100 will be described.

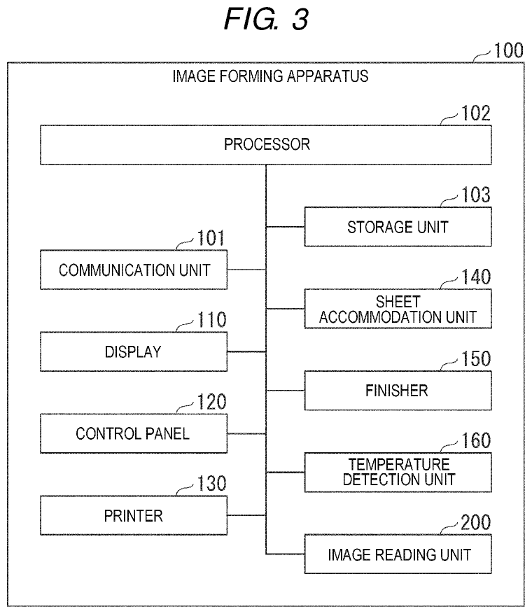

FIG. 3 is a block diagram illustrating a functional configuration of the image forming apparatus 100. The image forming apparatus 100 includes a communication unit 101, a processor 102, a storage unit 103, the display 110, the control panel 120, the printer 130, the sheet accommodation unit 140, the finisher 150, a temperature detection unit 160, and the image reading unit 200. As the configurations of the display unit 110, the control panel 120, the printer 130, the sheet accommodation unit 140, the finisher 150, and the image reading unit 200 have been described, the description thereof will not be repeated.

The communication unit 101 is a network interface. The communication unit 101 communicates with an external information processing apparatus via a communication path. The information processing apparatus is, for example, a personal computer, a server, or the like.

The processor 102 is, for example, a central processing unit (CPU). When the processor 102 is the CPU, the processor 102 operates as a control unit by reading a program from a memory and executing the program. The control unit controls each unit of the image forming apparatus 100. The processor 102 receives a printing job via the communication unit 101 or the control panel 120. The printing job is job data instructing to form an image on a sheet. The processor 102 controls each unit such that image data based on the printing job is formed as an image on the sheet.

The processor 102 functions as a notification control unit that controls a notification to a user. The processor 102 performs a notification, for example, by causing a notification unit such as the display 110 to display information. The processor 102 may be configured to output information to, for example, an output device such as an external display device instead of outputting the information to the notification unit included in the image forming apparatus 100. In this case, the processor 102 outputs information indicating a notification to the external output device.

The notification mentioned here also includes, for example, a notification for presenting an appropriate countermeasure method to a user when jamming occurs. The processor 102 performs a notification to the user, for example, by causing the display 110 to display text information. The processor 102 may be configured to perform output according to other output methods of, for example, displaying a notification image, outputting a notification sound, or causing a notification lamp to emit light instead of causing the notification unit to display the text information.

For example, the processor 102 causes the notification unit such as the display 110 to output another notification according to the remaining position of the jammed sheet detected by the detection unit 30. The processor 102 performs a first notification, for example, when the remaining position of the jammed sheet detected by the detection unit 30 is not a position that is a downstream side from the transfer unit 28 and an upstream side from the fixing unit 29 in the transport path 15 (hereinafter referred to as a “predetermined position”). The processor 102 also performs a second notification different from the first notification, for example, when the remaining position of the jammed sheet detected by the detection unit 30 is the predetermined position.

As described above, the predetermined position is a position which is a downstream side from the transfer unit 28 and an upstream side from the fixing unit 29 in the transport path 15. Accordingly, when jamming occurs and the remaining position of the jammed sheet is the predetermined position, it is a state in which toner is transferred to the jammed sheet, but the toner is not fixed. In addition, when jamming occurs and the remaining position of the jammed sheet is a position which is upstream from the predetermined position in the transport path 15, it is a state in which toner is not transferred to the sheet. When jamming occurs and the remaining position of the sheet is a position which is downstream from the predetermined position in the transport path 15, it is a state in which toner is transferred to the jammed sheet and the toner is fixed.

The storage unit 103 is any of various memories such as a hard disk drive (HDD) and a dynamic random access memory (DRAM). The storage unit 103 stores various kinds of data to be used by the processor 102 to perform a process and programs executed by the processor 102. The temperature detection unit 160 is a temperature sensor. The temperature detection unit 160 detects the temperature of the fixing unit 29.

Hereinafter, an operation example of the image forming apparatus 100 will be described.

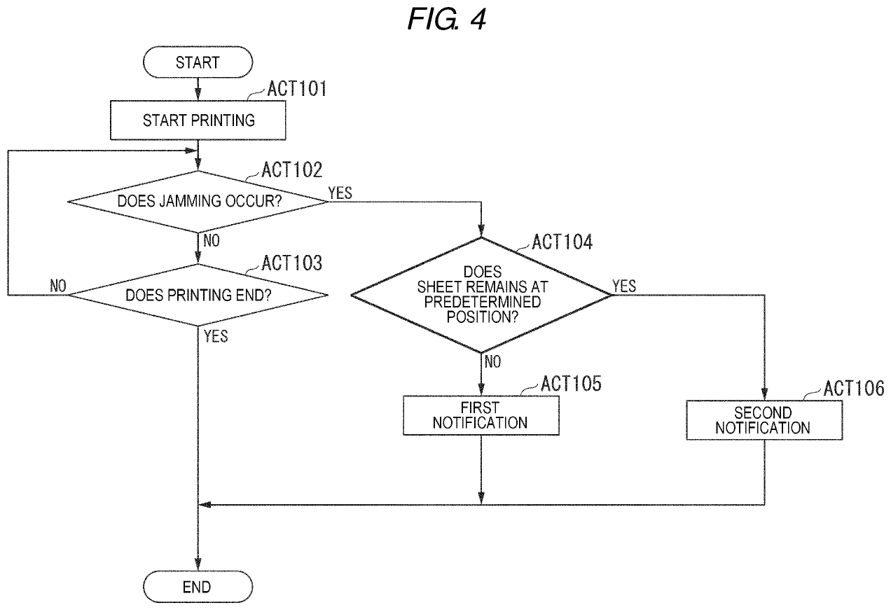

FIG. 4 is a flowchart illustrating an operation example of the image forming apparatus 100. An operation illustrated in the flowchart starts when the processor 102 receives a printing job via the communication unit 101 or the control panel 120.

The processor 102 starts a process for printing based on the printing job (ACT 101). The processor 102 monitors presence or absence of jamming. The processor 102 recognizes presence or absence of jamming based on whether information indicating the jamming is acquired from the detection unit 30. When the jamming is not detected (NO in ACT 102) and the printing ends (YES in ACT 103), the operation of the image forming apparatus 100 illustrated in the flowchart of FIG. 4 ends.

When the jamming is not detected (NO in ACT 102) and the printing does not end (NO in ACT 103), the processor 102 continues to monitor the presence or absence of jamming. When the jamming is detected (YES in ACT 102), the processor 102 specifies the position of the jammed sheet. The processor 102 specifies the position of the jammed sheet based on the information acquired from the detection unit 30. When the position of the jammed sheet is not the predetermined position (NO in ACT 104), the processor 102 causes the display 110 to display the first notification (ACT 105). Then, the operation of the image forming apparatus 100 illustrated in the flowchart of FIG. 4 ends.

Conversely, when the position of the jammed sheet is the predetermined position (YES in ACT 104), the processor 102 causes the display 110 to display the second notification (ACT 106). Then, the operation of the image forming apparatus 100 illustrated in the flowchart of FIG. 4 ends.

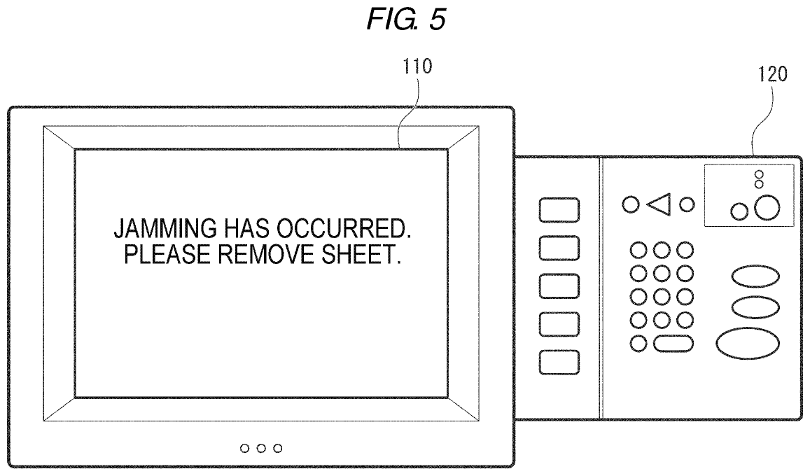

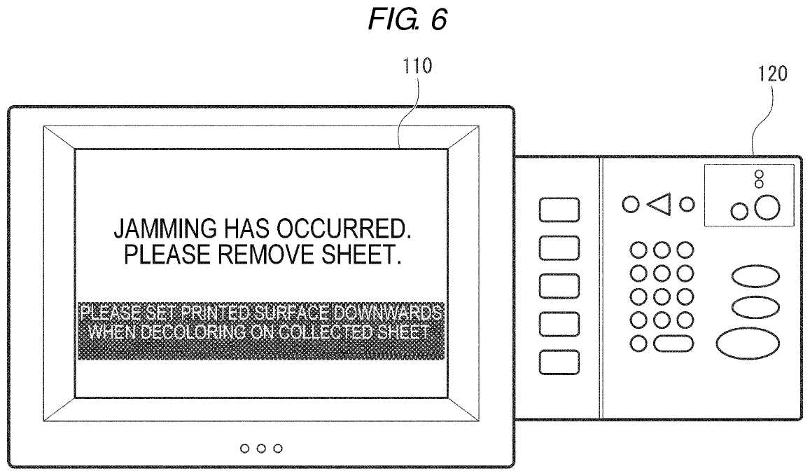

Display examples of the above-described first and second notifications at the time of performing printing using the decoloring toner are illustrated in FIGS. 5 and 6, respectively.

FIG. 5 is a schematic diagram illustrating a display example of a first notification. As illustrated, for example, a sentence “Jamming has occurred. Please remove the sheet.” is displayed on the display 110 for the first notification. FIG. 6 is a schematic diagram illustrating a display example of a second notification. As illustrated, for example, a sentence “Jamming has occurred. Please remove the sheet. Please set printed surface downwards when decoloring the collected sheet.” is displayed on the display 110 for the second notification.

As described above, for example, the second notification is text information in which the sentence “Please set printed surface downwards when decoloring the collected sheet.” are additionally indicated in the first notification. In a general decoloring unit (for example, a decoloring device), pickup rollers (for example, the pickup rollers 21A, 21B, and 21C) feeding a sheet come into contact with the sheet from the upper side of the sheet to draw the sheet to a transport path. Accordingly, “set printed surface downwards” means that the jammed sheet is set so that the printed surface faces a direction opposite to a direction toward the pickup rollers of the decoloring unit.

As described above, in the printing using the decoloring toner, a user may decolor the fixed or unfixed decoloring toner transferred to the collected jammed sheet and reuse the decolored sheet. In these cases, the jammed sheet is fed to the decoloring unit (for example, a decoloring device). At this time, when the jammed sheet is set in the decoloring unit so that a surface (printed surface) on which unfixed toner is ridden faces a direction in which the surface comes into contact with the pickup rollers of the decoloring unit, the unfixed toner is attached to the pickup rollers of the decoloring unit during feeding of the sheet. Thus, the fed sheet slips and thus is not normally fed in some cases. Accordingly, when the position of the jammed sheet is the predetermined position, it is necessary for the user to set the jammed sheet in the decoloring unit so that the printed surface faces a direction opposite to the direction toward the pickup rollers of the decoloring unit.

As described above, the image forming apparatus 100 according to the first embodiment performs, for example, the second notification illustrated in FIG. 6 when the position of the jammed sheet is the predetermined position. In this way, the image forming apparatus 100 according to the first embodiment can notify an appropriate countermeasure method to the user when jamming occurs.

Not only in the printing using the decoloring toner but also in printing using non-decoloring toner, the processor 102 may change the notification depending on whether or not the position of the jammed sheet is the predetermined position. In this case, for example, in the first notification in printing using non-decoloring toner, the processor 102 causes the display 110 to display the sentence “Jamming has occurred. Please remove the sheet.” On the other hand, in the second notification in printing using non-decoloring toner, the processor 102 causes the display 110 to display the sentence “Jamming has occurred. Please remove the sheet. Be careful to not touch printed surface since toner is not fixed.”, for example.

In the printing using non-decoloring toner, the removed jammed sheet is not set in the decoloring unit. However, even in the printing using non-decoloring toner, for example, the user can recognize whether the non-decoloring toner on the jammed sheet is unfixed toner by changing the notification depending on whether the position of the jammed sheet is the predetermined position. Thus, the image forming apparatus 100 can prompt a notice so that the user does not touch the unfixed toner.

### Second Embodiment

As described above, in the first embodiment, the image forming apparatus 100 performs different notifications depending on whether or not the position of the sheet is the predetermined position. In the second embodiment to be described below, an image forming apparatus 100 performs different notifications depending on whether or not jamming occurs during simplex printing or during duplex printing. When jamming occurs during duplex printing, the image forming apparatus 100 performs different notifications depending on whether jamming occurs during printing of the first surface or during printing of the second surface.

The configuration of the image forming apparatus 100 according to the second embodiment is basically common to the configuration of the image forming apparatus 100 according to the first embodiment described with reference to FIGS. 1 to 3. Accordingly, in the following description, only different aspects between the configuration of the image forming apparatus 100 according to the second embodiment and the configuration of the image forming apparatus 100 according to the first embodiment will be described.

The processor 102 causes the notification unit to output different notifications according to the position of a jammed sheet detected by the detection unit 30. For example, when the position of the jammed sheet detected by the detection unit 30 is not the predetermined position, the processor 102 performs the first notification. When the position of the jammed sheet detected by the detection unit 30 is the predetermined position, the processor 102 performs the second notification different form the first notification, or a third notification different from the first notification and the second notification. Specifically, for example, when the first surface is being printed in the simplex printing or the duplex printing, the processor 102 performs the second notification. Conversely, for example, when the second surface is being printed in the duplex printing, the processor 102 performs the third notification.

Hereinafter, an operation example of the image forming apparatus 100 will be described.

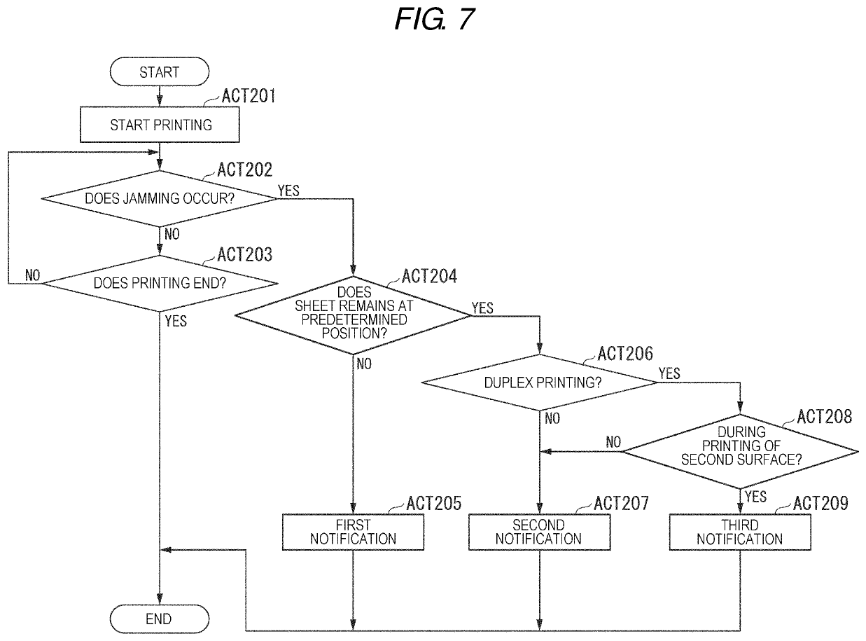

FIG. 7 is a flowchart illustrating an operation example of the image forming apparatus 100 according to the second embodiment. An operation illustrated in the flowchart starts when the processor 102 receives the printing job via the communication unit 101 or the control panel 120. Since the operation of ACT 201 to ACT 203 illustrated in FIG. 7 is common to the operation of ACT 101 to ACT 103 illustrated in FIG. 4, the description thereof will not be repeated.

When jamming is detected (YES in ACT 202), the processor 102 specifies the position of the jammed sheet. The processor 102 specifies the position of the jammed sheet based on the information acquired from the detection unit 30. When the position of the jammed sheet is not the predetermined position (NO in ACT 204), the processor 102 causes the display 110 to display the first notification (ACT 205). Then, the operation of the image forming apparatus 100 illustrated in the flowchart of FIG. 7 ends.

When the position of the jammed sheet is the predetermined position (YES in ACT 204) and the printing is not the duplex printing (that is, the printing is the simplex printing) (NO in ACT 206), the processor 102 causes the display 110 to display the second notification (ACT 207). Then, the operation of the image forming apparatus 100 illustrated in the flowchart of FIG. 7 ends.

When the position of the jammed sheet is the predetermined position (YES in ACT 204) and the printing is the duplex printing (YES in ACT 206), the processor 102 determines whether the first surface is being printed or the second surface is being printed. When the first surface is being printed (NO in ACT 208), the processor 102 causes the display 110 to display the second notification (ACT 207). Then, the operation of the image forming apparatus 100 illustrated in the flowchart of FIG. 7 ends.

When the second surface is being printed (YES in ACT 208), the processor 102 causes the display 110 to display the third notification (ACT 209). Then, the operation of the image forming apparatus 100 illustrated in the flowchart of FIG. 7 ends.

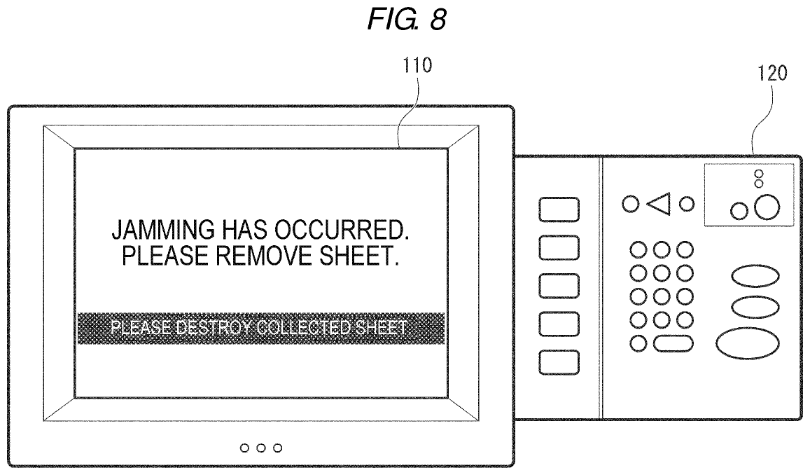

Since display examples of the above-described first and second notifications during printing using the decoloring toner are common to the display examples illustrated in FIGS. 5 and 6, respectively, the description thereof will not be repeated. A display example of the above-described third notification during printing using the decoloring toner is illustrated in FIG. 8.

FIG. 8 is a schematic diagram illustrating a display example of the third notification. As illustrated in FIG. 5, for example, a sentence “Jamming has occurred. Please remove the sheet.” is displayed on the display 110 for the first notification. On the other hand, as illustrated in FIG. 8, for example, a sentence “Jamming has occurred. Please remove the sheet. Please discard the collected sheet.” is displayed on the display 110 in the third notification.

As described above, for example, the third notification is text information in which the sentence “Please discard the collected sheet.” are indicated in addition to the first notification. As described above, the image forming apparatus 100 according to the second embodiment performs, for example, the third notification illustrated in FIG. 8 when the position of the jammed sheet is the predetermined position and the printing is the printing of the second surface in the duplex printing.

When the position of the jammed sheet is the predetermined position and jamming occurs during the printing of the second surface in the duplex printing, it is a state in which fixed toner is on the first surface of the jammed sheet and unfixed toner is on the second surface of the jammed sheet. In this case, since the toner is transferred to both surfaces of the sheet, it is not easy for the user to determine which surface is the first surface and which surface the second surface.

Thus, the user may erroneously set the sheet so that the surface (the second surface) on which the unfixed toner is formed faces a direction in which the surface comes into contact with the pickup roller of the decoloring unit. In this case, the unfixed tonner is attached to the pickup roller of the decoloring unit during feeding. The fed sheet slips and thus may not be normally fed.

As described above, the image forming apparatus 100 according to the second embodiment performs, for example, a notification for prompting the user to discard the jammed sheet when the position of the jammed sheet is the predetermined position and jamming occurs during the printing of the second surface in the duplex printing. The image forming apparatus 100 performs, for example, the second notification illustrated in FIG. 6 when the position of the jammed sheet is the predetermined position and jamming occurs during the simplex printing or the printing of the first surface in the duplex printing. This is because, in this case, it is easy for the user to determine the surface on which the unfixed toner is formed since the toner is formed on only one surface of the sheet. In this way, the image forming apparatus 100 according to the second embodiment can notify an appropriate countermeasure method to the user when jamming occurs.

### Third Embodiment

As described above, in the second embodiment, the image forming apparatus 100 performs the different notifications depending on whether or not the position of a sheet is the predetermined position. In the second embodiment, the image forming apparatus 100 performs different notifications depending on whether jamming occurs during simplex printing or duplex printing. In the second embodiment, when jamming occurs during the duplex printing, the image forming apparatus 100 performs different notifications depending on whether the jamming occurs during the printing of the first surface or the jamming occurs during the printing of the second surface.

In the third embodiment to be described below, the image forming apparatus 100 further performs different notifications depending on whether jamming occurs in printing using decoloring toner or jamming occurs in printing using non-decoloring toner.

The configuration of the image forming apparatus 100 according to the third embodiment is basically common to the configuration of the image forming apparatus 100 according to the first embodiment described with reference to FIGS. 1 to 3. Accordingly, in the following description, only different aspects between the configuration of the image forming apparatus 100 according to the third embodiment and the configuration of the image forming apparatus 100 according to the first embodiment will be described.

The processor 102 performs different notifications according to the position of the jammed sheet detected by the detection unit 30. For example, when the position of the jammed sheet detected by the detection unit 30 is not the predetermined position, the processor 102 performs the first notification. When the position of the jammed sheet detected by the detection unit 30 is the predetermined position, the processor 102 performs the second notification different from the first notification, or the third notification different from the first notification and the second notification. Specifically, when jamming occurs in printing using non-decoloring toner, the processor 102 performs the third notification.

When the jamming occurs in printing using decoloring toner, the processor 102 performs the second notification or the third notification. Specifically, when the first surface is being printed in the simplex printing or the duplex printing, the processor 102 performs the second notification. When the second surface is printed in the duplex printing, the processor 102 performs the third notification.

Hereinafter, an operation example of the image forming apparatus 100 will be described.

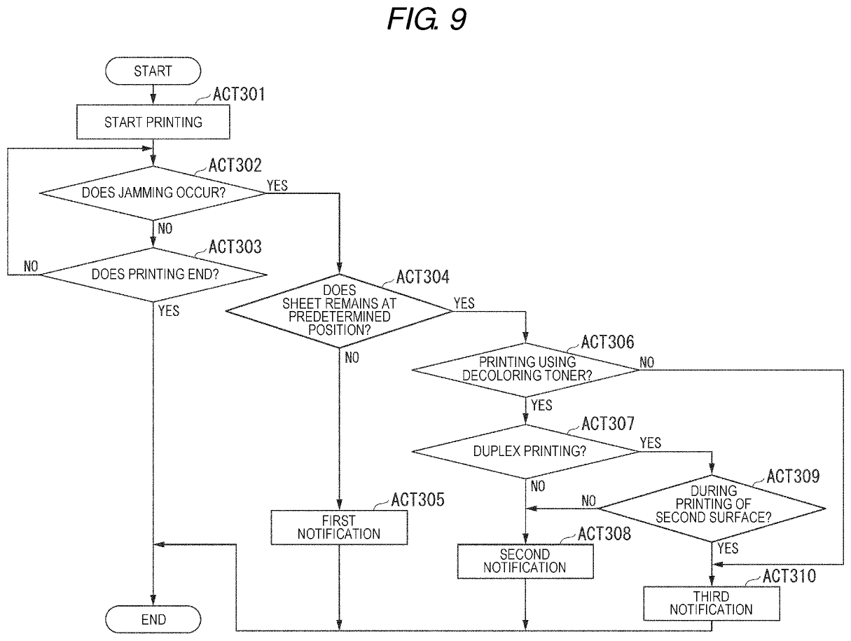

FIG. 9 is a flowchart illustrating an operation example of the image forming apparatus 100 according to the third embodiment. An operation illustrated in the flowchart starts when the processor 102 receives the printing job via the communication unit 101 or the control panel 120. Since the operation of ACT 301 to ACT 303 illustrated in FIG. 9 is common to the operation of ACT 101 to ACT 103 illustrated in FIG. 4, the description thereof will not be repeated.

When jamming is detected (YES in ACT 302), the processor 102 specifies the position of the jammed sheet. The processor 102 specifies the position of the jammed sheet based on the information acquired from the detection unit 30. When the position of the jammed sheet is not the predetermined position (NO in ACT 304), the processor 102 causes the display 110 to display the first notification (ACT 305). Then, the operation of the image forming apparatus 100 illustrated in the flowchart of FIG. 9 ends.

When the position of the jammed sheet is the predetermined position (YES in ACT 304), the processor 102 determines whether printing is using decoloring toner or non-decoloring toner. When the printing is not using the decoloring toner (is using the non-decoloring toner) (NO in ACT 306), the processor 102 causes the display 110 to display the third notification (ACT 310). Then, the operation of the image forming apparatus 100 illustrated in the flowchart of FIG. 9 ends.

When the printing is using decoloring toner (YES in ACT 306) and the printing is not the duplex printing (that is, the printing is the simplex printing) (NO in ACT 307), the processor 102 causes the display 110 to display the second notification (ACT 308). Then, the operation of the image forming apparatus 100 illustrated in the flowchart of FIG. 9 ends.

When the printing is using the decoloring toner (YES in ACT 306) and the printing is the duplex printing (YES in ACT 307), the processor 102 determines whether the first surface is being printed or the second surface is being printed. When the first surface is being printed (NO in ACT 309), the processor 102 causes the display 110 to display the second notification (ACT 308). Then, the operation of the image forming apparatus 100 illustrated in the flowchart of FIG. 9 ends.

When the second surface is being printed (YES in ACT 309), the processor 102 causes the display 110 to display the third notification (ACT 310). Then, the operation of the image forming apparatus 100 illustrated in the flowchart of FIG. 9 ends.

For example, the display examples illustrated in FIGS. 5, 6, and 8 can be used as the above-described first notification, second notification, and third notification, respectively.

As described above, the image forming apparatus 100 according to the third embodiment performs, for example, the third notification illustrated in FIG. 9 when jamming occurs in the printing using the non-decoloring toner and the position of the jammed sheet is the predetermined position. That is, in this case, the image forming apparatus 100 performs a notification for prompting the user to discard the jammed sheet. This is because when the toner on the jammed sheet is non-decoloring toner and unfixed toner, the jammed sheet may not be decolored and reused and an object (for example, the inside of the image forming apparatus 100, the body of the user, or the like) coming into contact with the unfixed toner is likely to become dirty. In this way, the image forming apparatus 100 according to the third embodiment can notify the user of an appropriate countermeasure method when jamming occurs.

According to at least one of the above-described embodiments, by including the processor 102 that performs different notifications depending on whether or not the position of the jammed sheet is the predetermined position, the user can be notified of the appropriate countermeasure method when jamming occurs.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein maybe made without departing from the spirit of the inventions. The accompanying claims and their equivalents are intended to cover such forms or modifications as would fall within the scope and spirit of the invention.

What is claimed is:

1. An image forming apparatus comprising:
an image transfer device;
an image fixing device disposed downstream with respect to the image transfer device in a sheet conveying direction, and configured to fix a toner image transferred onto a sheet by the image transfer device;
one or more sheet sensors disposed along a sheet conveying path;
a control panel; and
a controller configured to:
determine whether or not a jammed sheet is at least partially positioned between the image transfer device and the image fixing device based on a detection result of the one or more sheet sensors; and
control the control panel to display different procedures to handle the jammed sheet, depending on the determination whether or not the jammed sheet is at least partially positioned between the image transfer device and the image fixing device.

2. The image forming apparatus according to claim 1, wherein the controller is configured to:
control the control panel to display a first procedure to handle the jammed sheet when determining that the jammed sheet is not positioned between the image transfer device and the image fixing device, and
control the control panel to display a second procedure to handle the jammed sheet when determining that the jammed sheet is at least partially positioned between the image transfer device and the image fixing device.

3. The image forming apparatus according to claim 1, wherein the controller is further configured to:
determine whether or not a duplex printing is performed for the jammed sheet, and
control the control panel to display different procedures to handle the jammed sheet, also depending on the determination whether or not a duplex printing is performed for the jammed sheet.

4. The image forming apparatus according to claim 3, wherein the controller is further configured to:
determine whether or not an image transfer on a second surface has started for the jammed sheet after an image fixing on a first surface of the jammed sheet when a sheet jam occurs, and
control the control panel to display different procedures to handle the jammed sheet, also depending on the determination whether or not the image transfer on the second surface has started.

5. The image forming apparatus according to claim 4, wherein the controller is further configured to:
control the control panel to display a first procedure to handle the jammed sheet when determining that the jammed sheet is not positioned between the image transfer device and the image fixing device,
control the control panel to display a second procedure to handle the jammed sheet when determining that:
i) the jammed sheet is at least partially positioned between the image transfer device and the image fixing device, and the duplex printing is not performed for the jammed sheet, and
ii) the jammed sheet is at least partially positioned between the image transfer device and the image fixing device, the duplex printing is performed for the jammed sheet, and the image transfer on the second surface has not started.

6. The image forming apparatus according to claim 5, wherein the controller is further configured to:
control the control panel to display a third procedure to handle the jammed sheet when determining that the jammed sheet is at least partially positioned between the image transfer device and the image fixing device, the duplex printing is performed for the jammed sheet, and the image transfer on the second surface has started.

7. The image forming apparatus according to claim 6, wherein
the second procedure includes removing the jammed sheet and setting the removed jammed sheet in sheet storage with a non-fixed image on a particular side, and the third procedure includes removing the jammed sheet and discarding the jammed sheet.

8. The image forming apparatus according to claim 3, wherein the controller is further configured to:
determine whether or not a printing with decoloring toner is performed for the jammed sheet, and
control the control panel to display different procedures to handle the jammed sheet, also depending on the determination whether or not the printing with decoloring toner is performed for the jammed sheet.

9. The image forming apparatus according to claim 8, wherein the controller is further configured to:
control the control panel to display a first procedure to handle the jammed sheet when determining that the jammed sheet is not positioned between the image transfer device and the image fixing device,
control the control panel to display a second procedure to handle the jammed sheet when determining that:
i) the jammed sheet is at least partially positioned between the image transfer device and the image fixing device, the printing with decoloring toner is performed for the jammed sheet, and the duplex printing is not performed for the jammed sheet, and
ii) the jammed sheet is at least partially positioned between the image transfer device and the image fixing device, the printing with decoloring toner is performed for the jammed sheet, the duplex printing is performed for the jammed sheet, and the image transfer on the second surface has not started.

10. The image forming apparatus according to claim 9, wherein the controller is further configured to:
control the control panel to display a third procedure to handle the jammed sheet when determining that:
iii) the jammed sheet is at least partially positioned between the image transfer device and the image fixing device, and the printing with decoloring toner is not performed for the jammed sheet, and
iv) the jammed sheet is at least partially positioned between the image transfer device and the image fixing device, the printing with decoloring toner is performed for the jammed sheet, the duplex printing is performed for the jammed sheet, and the image transfer on the second surface has started.

11. An operation method of an image forming apparatus including an image transfer device, an image fixing device disposed downstream with respect to the image transfer device in a sheet conveying direction, and a control panel, the method comprising:
detecting a sheet jam;
determining whether or not a jammed sheet is at least partially positioned between the image transfer device and the image fixing device; and
displaying, on the control panel, different procedures to handle the jammed sheet, depending on the determination whether or not the jammed sheet is at least partially positioned between the image transfer device and the image fixing device.

12. The operation method according to claim 11, wherein said displaying different procedures includes:
displaying, on the control panel, a first procedure to handle the jammed sheet when the jammed sheet is not positioned between the image transfer device and the image fixing device, and
displaying, on the control panel, a second procedure to handle the jammed sheet when the jammed sheet is at least partially positioned between the image transfer device and the image fixing device.

13. The operation method according to claim 11, further comprising:
determining whether or not a duplex printing is performed for the jammed sheet, wherein
the different procedures to handle the jammed sheet are displayed also depending on the determination whether or not a duplex printing is performed for the jammed sheet.

14. The operation method according to claim 11, further comprising:
determining whether or not an image transfer on a second surface has started for the jammed sheet after an image fixing on a first surface of the jammed sheet when a sheet jam occurs, wherein
the different procedures to handle the jammed sheet are displayed also depending on the determination whether or not the image transfer on the second surface has started.

15. The operation method according to claim 11, further comprising:
determining whether or not a printing with decoloring toner is performed for the jammed sheet, wherein
the different procedures to handle the jammed sheet are displayed also depending on the determination whether or not the printing with decoloring toner is performed for the jammed sheet.

16. An operation method of an image forming apparatus including an image transfer device, an image fixing device disposed downstream with respect to the image transfer device in a sheet conveying direction, and a control panel, the method comprising:
detecting a sheet jam;
when a jammed sheet includes no non-fixed toner image thereon, displaying, on the control panel, a first procedure to handle the jammed sheet; and
when the jammed sheet includes a non-fixed toner image thereon, displaying, on the control panel, a second procedure to handle the jammed sheet, the second procedure including a different process from the first procedure.

17. The operation method according to claim 16, wherein the second procedure is displayed when the non-fixed toner image is formed on a surface of the jammed sheet opposite to a non-printed surface, and the method further comprises:
when the non-fixed toner image is formed on a surface of the jammed sheet opposite to a printed surface, displaying, on the control panel, a third procedure to handle the jammed sheet, the third procedure including a different process from the first and second procedures.

18. The operation method according to claim 16, wherein the second procedure is displayed when the non-fixed toner image is formed of decoloring toner, and the method further comprises:
when the non-fixed toner image is formed of non-decoloring toner, displaying, on the control panel, a third procedure to handle the jammed sheet, the third procedure including a different process from the first and second procedures.
